(19) United States
(12) Patent Application Publication
(10) Pub. No.: US 2005/0050348 A1
(43) Pub. Date: Mar. 3, 2005

(54) Method for copy protection of DVD recorder

(75) Inventor: Yuan-Chang Chin, Taipei (TW)

Correspondence Address: TROXELL LAW OFFICE PLLC, SUITE 1404, 5205 LEESBURG PIKE, FALLS CHURCH, VA, 22041, US

(73) Assignee: Ali Corporation

(21) Appl. No.: 10/740,624

(22) Filed: Dec. 22, 2003

(30) Foreign Application Priority Data
Aug. 29, 2003 (TW) 92124050

(51) Int. Cl. H04L 9/00

(52) U.S. Cl. 713/200

(57) ABSTRACT

A method for copy protection of DVD recorder with a microprocessor connected with a primary chipset in a DVD recorder. First, the microprocessor generates three bytes stored into a buffer. The buffer is a data memory in the microprocessor. The three bytes in the buffer are then read to the primary chipset in the DVD recorder. The first byte is checked to see whether it is wrong or not. If there is no error, the other two bytes are received, and the three bytes are then sent back to the microprocessor, which checks whether the three bytes are correct or not for at least once. If the three bytes are correct, the primary chipset in the DVD recorder is determined to be genuine, and the DVD recorder can record.

### FIELD OF THE INVENTION

The present invention relates to a method for copy protection of DVD recorder, which function through a microprocessor connected with a primary chipset in a DVD recorder. Internal codes of the microprocessor can't be copied when the microprocessor is burned out. Three bytes are transmitted between the microprocessor and the primary chipset in the DVD recorder. The accuracy of the three bytes is checked for protecting firmware in the primary chipset in the DVD recorder.

### BACKGROUND OF THE INVENTION

Because of shorter life cycles of today's electronic products, some unworthy manufacturers use various ways to get hardware products of competitors and then directly decompose Gerber data out of real circuit boards. They make use of a frying way to separate multi-layer boards and then send to a layout company for copying circuits therein and make the same circuit boards. Without any circuit diagram, they can duplicate the circuit to accomplish one hundred percents of copy.

As for firmware, most of them are now moved to flash ROMs for access. Early manufacturers would store boot codes and kernel codes separately. The boot codes will be stored into EEPROMs, while the kernel codes will be stored into flash ROMs. Due to higher cost of EEPROM, most manufacturers remove EEPROMs from circuit boards and store the boot codes and kernel codes together into flash ROMs to lower the cost.

Although the way of directly storing firmware into flash ROMs can lower the cost, a very big danger arises. That is, firmware can be easily copied. An unworthy manufacturer only needs to dismantle the flash ROM from a circuit board and then use a burner to burn into a new flash ROM of the same type one bit after another, thereby duplicating a flash ROM having the same content.

As stated above, unworthy manufacturers can easily acquire whole hardware and firmware without any research expenses so as to let research achievements of the original company be irrevocably lost.

### SUMMARY OF THE INVENTION

Accordingly, the present invention aims to propose a method for copy protection of DVD recorder. In this method, a microprocessor is added in the hardware. One or more I/O pins of the microprocessor are connected to the GPIO (general purpose I/O) set pins of a primary chipset in a DVD recorder. Simultaneously, a two-wired synchronous serial I/O set is used to response to arbitrary values for protecting firmware. In the present invention, the microprocessor is used because its program codes are stored in a burned-out way and thus can't be copied easily.

The primary object of the present invention is to provide a method for copy protection of DVD recorder. In this method, the microprocessor first generates three bytes stored into a buffer. The buffer is a data memory in the microprocessor. Next, the three bytes in the buffer are read and sent to a primary chipset in a DVD recorder. The first one of the three bytes is then checked. If there is no error, the other two bytes are received, and the three bytes are then sent back to the microprocessor for checking whether the three bytes are correct or not for at least once. If the three bytes are correct, the primary chipset in the DVD recorder is determined to be genuine, and the DVD recorder thus can record.

The various objects and advantages of the present invention will be more readily understood from the following detailed description when read in conjunction with the appended drawings, in which:

### BRIEF DESCRIPTION OF THE DRAWINGS

FIG. 1 is a system architecture diagram of the present invention;

FIG. 2 is a system circuit block diagram of the present invention; and

FIG. 3 is a flowchart of a copy protection procedure of the present invention.

### DETAILED DESCRIPTION OF THE PREFERRED EMBODIMENTS

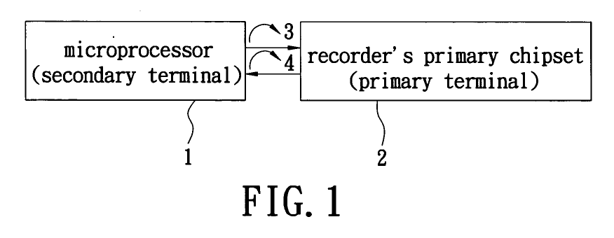

As shown in FIG. 1, a microprocessor 1 is connected to a primary chipset 2 in a DVD recorder. The microprocessor 1 makes use of I/O set pins 3 to communicate with the primary chipset 2 in the DVD recorder. Simultaneously, a two-wired synchronous serial I/O set 4 is used to let the microprocessor 1 and the primary chipset 2 in the DVD recorder be connected together and transmit signals mutually.

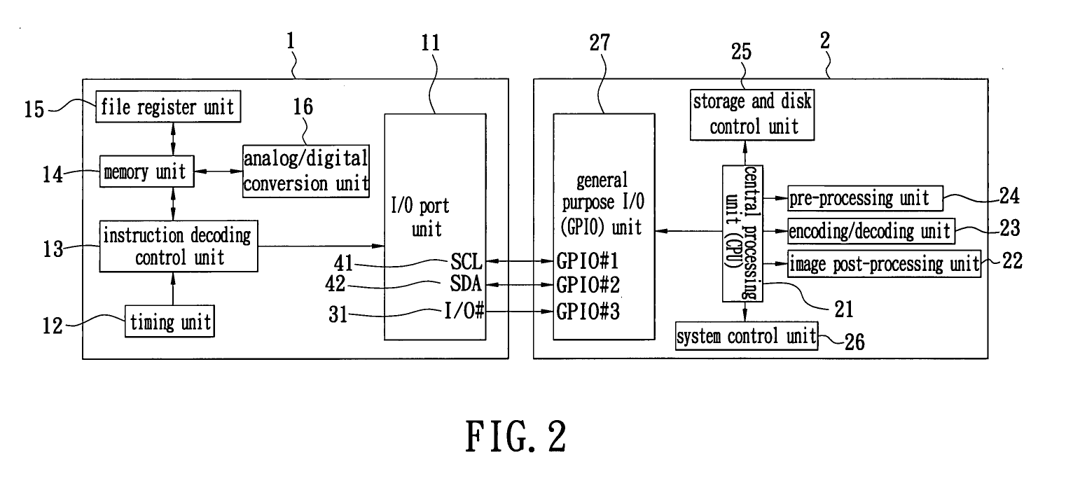

As shown in FIG. 2, the microprocessor 1 comprises an I/O port unit 11, at least a timing unit 12, an instruction decoding and control unit 13, at least a memory unit 14, a file register unit 15 and an analog/digital conversion unit 16.

The I/O port unit 11 further comprises a Serial CLock (SCL) signal 41, Serial DAta (SDA) signal 42 and an I/O pin signal 43. The Serial CLock (SCL) signal 41 and the SDA signal 42 are signals of two pins of the two-wired synchronous serial I/O set 4. When the level of the Serial CLock (SCL) signal 41 changes (from a high level to a low one or vice versa), the microprocessor 1 and the primary chipset 2 in the DVD recorder will be connected together for data transmission with the SDA signal 42. The I/O pin signal 43 is outputted from the microprocessor 1 to the primary chipset 2 in the DVD recorder. The instruction decoding and control unit 13 of the microprocessor 1 issues an I/O instruction, which is sent to the primary chipset 2 in the DVD recorder via the I/O port unit 11 to let the primary chipset 2 in the DVD recorder execute a specific I/O action.

The timing unit 12 of the microprocessor 1 further comprises a timer and a power activation timer. The memory unit 14 of the microprocessor 1 further comprises a flash ROM and a data memory. The data memory is used to store bytes generated by the microprocessor 1.

As shown in FIG. 2, the primary chipset 2 in the DVD recorder comprises a central processing unit (CPU) 21, an image post-processing unit 22, at least an encoding/decoding unit 23, a pre-processing unit 24, a storage and disk control unit 25, a system control unit 26 and a GPIO unit 27.

The GPIO unit 27 further comprises three receiving pins: a SCL signal receiving pin, a SDA signal receiving pin, and an I/O signal receiving pin. The GPIO unit 27 is used to receive signals from the microprocessor 1 and respond results generated by the primary chipset 2 in the DVD recorder to the microprocessor.

The encoding/decoding unit 23 of the primary chipset 2 in the DVD recorder comprises a common audio/video (AV) encoder/decoder. The AV encoder/decoder has the function of encoding and decoding sounds and images. The image post-processing unit 22 comprises an NTSC/PAL encoder (TV encoder) for analog signals. The NTSC format is a television image specification developed by the RCA company, USA, while the PAL format is a television image specification (European specification) developed by the Telefunken company, Germany.

The method for protecting firmware of a copy protection DVD recorder circuit of the present invention will be illustrated below.

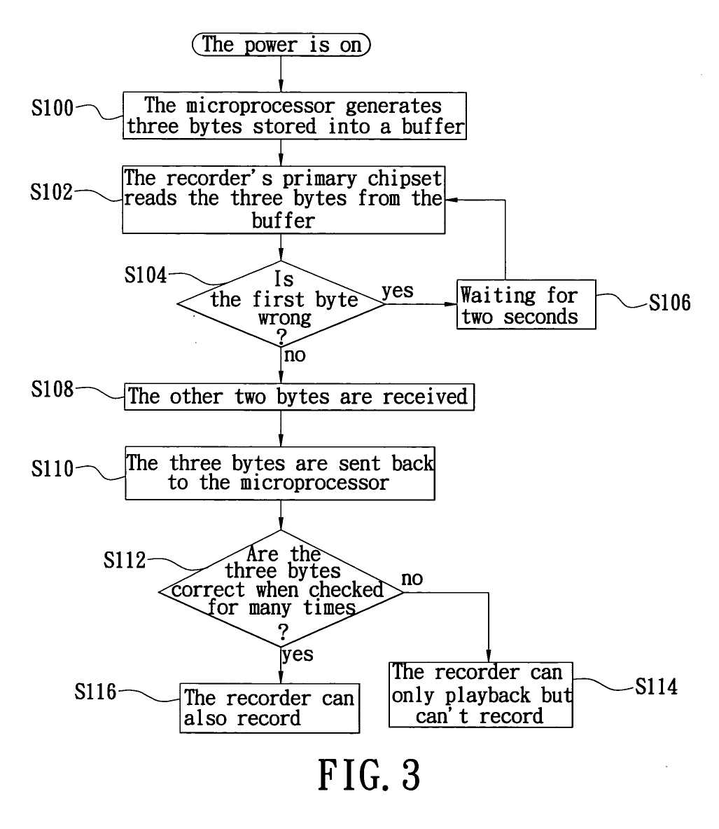

As shown in FIG. 3, the microprocessor 1 first generates three bytes stored into a data memory (buffer) of the memory unit 14 of the microprocessor 1 to be read by the primary chipset 2 in the DVD recorder. The primary chipset 2 in the DVD recorder makes use of signals of two pins in the GPIO unit 27 for data transmission. The two signals are the Serial CLock (SCL) signal 41 and the SDA signal 42 of the two-wired synchronous serial I/O set 4. The Serial CLock (SCL) signal 41 is transmitted via the first pin of the GPIO unit 271 of the primary chipset 2 in the DVD recorder. The SDA signal 42 is transmitted via the second pin of the GPIO unit 272 of the primary chipset 2 in the DVD recorder. When the level of the Serial CLock (SCL) signal 41 changes from a high level to a low one or vice versa, three bytes will be read from the data memory (buffer) of the memory unit 14 of the microprocessor 1 with the SDA signal 42 and sent to the primary chipset 2 in the DVD recorder for checking whether the three bytes are correct. The first one of the three bytes is an ID code specially for the microprocessor 1. The ID code is some hexadecimal value. The second byte is a number of times of communication between the microprocessor 1 and the primary chipset 2 in the DVD recorder. The third byte is an arbitrary value generated by the microprocessor 1. This arbitrary value is some hexadecimal value. If the microprocessor 1 can't automatically generate this arbitrary value, a counter in the microprocessor 1 can be used to obtain this arbitrary value.

After the primary chipset 2 in the DVD recorder receives the three bytes, it first checks whether the first byte is correct. If the first byte is wrong, the primary chipset 2 in the DVD recorder won't send the three bytes back to the microprocessor 1. After waiting for about 2 seconds, the microprocessor 1 will send the three bytes to the primary chipset 2 in the DVD recorder again. The first byte is checked again to see whether it is correct. If the first byte is correct, the primary chipset 2 in the DVD recorder continues to receive the other two bytes, and the three bytes are then send back to the microprocessor 1. The first byte of the received three bytes is the ID code of the primary chipset 2 in the DVD recorder. This ID code is some hexadecimal value. The second byte is a number of times of communication between the microprocessor 1 and the primary chipset 2 in the DVD recorder. The third byte is an arbitrary value generated by the microprocessor 1. This arbitrary value is some hexadecimal value. Because it is more difficult to generate this arbitrary value, a timer in the primary chipset 2 in the DVD recorder can perform an AND operation to obtain this arbitrary value, e.g., chip_risc_timer&0xFF, where the chip_risc_timer is a micro-instruction, whose function is to pick an arbitrary value of the timer to perform an AND operation with a hexadecimal value 0xFF (255 in decimal format). The above procedures are continued for at least once. If there is no error, the DVD recorder can playback and record normally. If there is any error, the microprocessor 1 will send out a high-level voltage signal via the I/O pin signal 43 to the third pin of the GPIO unit 273 of the primary chipset 2 in the DVD recorder. Otherwise, the I/O pin signal 43 will send a low-level voltage signal to the primary chipset 2 in the DVD recorder. In other words, whether the primary chipset 2 in the DVD recorder is genuine or not is determined through the level of the I/O pin signal 43. If the primary chipset 2 in the DVD recorder is determined to be pirated according to the level of this signal, the DVD recorder can only playback but can't record.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A method for copy protection of DVD recorder with a microprocessor connected to a primary chipset in a DVD recorder, said method at least comprising the steps of:
generating three bytes stored into a data memory, which is located in a memory unit of said microprocessor;
reading said three bytes from said data memory into said primary chipset in said DVD recorder;
checking whether the first byte is wrong or not;
receiving the other two bytes;
sending said three bytes back to said microprocessor; and
checking whether said three bytes are correct or not for many times;

2. The method for copy protection of DVD recorder as claimed in claim 1, wherein the step of generating three bytes is accomplished by said microprocessor, and said three bytes are stored into said data memory of said microprocessor.

3. The method for copy protection of DVD recorder as claimed in claim 1, wherein said step of reading said three bytes is accomplished by using said primary chipset in said DVD recorder to read said three bytes from said data memory of said microprocessor.

4. The method for copy protection of DVD recorder as claimed in claim 1, wherein the first one of said three bytes is an ID code specially for said microprocessor, the second byte is a number of times of communication between said microprocessor and said primary chipset in said DVD recorder, and the third byte is an arbitrary value.

5. The method for copy protection of DVD recorder as claimed in claim 1, wherein said three bytes are read from said data memory of said microprocessor again after a predetermined time elapses if the answer is yes in said step of checking whether said first byte is wrong or not; otherwise the next step is continued.

6. The method for copy protection of DVD recorder as claimed in claim 5, wherein said predetermined time is 2 seconds.

7. The method for copy protection of DVD recorder as claimed in claim 1, wherein said primary chipset in said DVD recorder continues to receive the second and third bytes from said data memory of said microprocessor in said step of receiving the other two bytes if the first byte is checked to be correct.

8. The method for copy protection of DVD recorder as claimed in claim 1, wherein said step of sending said three bytes back to said microprocessor is accomplished by said primary chipset in said DVD recorder.

9. The method for copy protection of DVD recorder as claimed in claim 8, wherein the first one of said three bytes is an ID code of said primary chipset in said DVD recorder, the second byte is a number of times of communication between said microprocessor and said primary chipset in said DVD recorder, and the third byte is an arbitrary value.

10. The method for copy protection of DVD recorder as claimed in claim 9, wherein said ID code is some hexadecimal value, and said arbitrary value is also some hexadecimal value.

11. The method for copy protection of DVD recorder as claimed in claim 9, wherein said three bytes that are received and sent back are checked to see whether said three bytes are correct or not for at least once in said step of checking whether said three bytes are correct for many times, the primary chipset in said DVD recorder is determined to be genuine and said DVD recorder can record if the answer is yes; otherwise said primary chipset in said DVD recorder is determined to be pirated and said DVD recorder can only playback but can't record.
